(19) United States
(12) Patent Application Publication
(10) Pub. No.: US 2010/0140164 A1
(43) Pub. Date: Jun. 10, 2010

(54) USE OF A MATERIAL AS A FILTER BASE MATERIAL, A METHOD FOR FABRICATING A FILTER BASE MATERIAL, A FILTER BASE MATERIAL AND A FILTER

(75) Inventors: Björn Claeson, Bredaryd (SE); Bo Ekman, Bredaryd (SE); Sidsel Kristiansen, Svenljunga (SE); Patrik Ödling, Vadstena (SE)

Correspondence Address: MAIER & MAIER, PLLC, 1000 DUKE STREET, ALEXANDRIA, VA, 22314, US

(73) Assignee: DINAIR DEVELOPMENT AB, Vdstena (SE)

(21) Appl. No.: 12/600,430

(22) PCT Filed: May 15, 2008
(86) PCT No.: PCT/SE08/00335

§ 371 Date: Dec. 24, 2009

(30) Foreign Application Priority Data
May 16, 2007 (SE) 0701191-9

(51) Int. Cl. B01D 39/08; C08L 35/02

(52) U.S. Cl. 210/500.1; 525/225; 525/190

(57) ABSTRACT

Use of a material comprising a first polylactic acid and a first non-polylactic acid polyester as a filter base material (2) for a fluid cleaning filter. Furthermore, a method for fabricating a filter base material (2) as well as a filter base material (2) obtainable by the method and a filter comprising the filter base material (2) are provided.

### TECHNICAL FIELD OF THE INVENTION

The present invention generally relates to a use of a material as a filter base material for a fluid cleaning filter, such as an air cleaning filter. The invention also relates to a method for fabricating a filter base material, a filter base material and to a fluid filter comprising the filter base material.

### TECHNICAL BACKGROUND

Fluid cleaning filters, such as air cleaning filters, wherein the filters are used for removing particulate material from fluid streams are included in various arrangements such as Heating, Ventilation and Air conditioning (HVAC) arrangements. Typically, an air cleaning filter comprises a filter housing or frame, in which a filter base material (filter media) is provided for filtration of an air stream passing through the filter base material. A well-known filter base material comprises a carded nonwoven material of fibers. This material may be comprised of materials such as various polymers, cotton, rayon, acrylics etc (e.g., see WO 2007/02445 A1). A filter such as an air cleaning filter should provide a filter base material that removes particles from an air stream as the particles come in contact with the surface of the fibers in the filter base material and adhere to the fibers. The mechanisms by which the particles come in contact with and adhere to the fibers are known to relate to the sieving, interception, diffusion and electrostatic attraction phenomena. The relative effects of all these phenomena depend on how the filter is constructed. Examples of important factors to consider during the construction of an filter base material are the type of fibers, weight of the material per square meter of filter base material, the loft (thickness/depth) of the filter base material, fiber diameter, charge of fibers and the sizes of the dust particles aimed to be captured.

During the life cycle of fluid cleaning filters, the filters, or in particular the filter base materials load with particles over time, and their particle collection efficiency and pressure drop typically increase, the latter in particular for mechanical filters. Eventually, the increased pressure drop significantly inhibits airflow, and the filters or the filter base materials have to be replaced. For this reason, pressure drop across filters is often monitored because it indicates when to replace a filter or a filter base material. The filters or filter base materials of mechanical filters are normally replaced when the final pressure drop is reached. Therefore, it has been a general aim to provide disposable filter base materials that are renewable and non-polluting. A known disposable filter base material that would provide this comprises polylactic acid (PLA) in the form of fibers. PLA is attractive as a sustainable alternative to petrochemical-derived products, since the lactate from which it is ultimately produced can be derived from the fermentation of agricultural by-products such as corn starch or other starch-rich crops like barley, sugar or wheat. Furthermore, PLA is biodegradable and can be converted for possible re-use in growing more crops, in turn for future conversion to PLA.

In many filters, such as the filters of the G2 to F6 classes according to the Eurovent standard EN779:2002 as well as prefilms of the F7 class, the filter base material shall preferably be provided as a “high loft” and have a good mechanical strength to avoid compressions and, depending on the desired filter type, also to avoid fluid pressure drops, so as to provide efficient filtrations of air streams, for example. The skilled person in the art will appreciate the meaning of “loft” as a term for the thickness (depth) of the filter base material at a specified weight per area unit, wherein a “high loft” material may provide a filter base material having a small filter area while still being efficient in filtration as compared to a filter base material of less thickness than the “high loft” filter base material.

A filter base material consisting of PLA has limitations in that a nonwoven filter base material made of PLA fibers does not provide the “high loft” material that is required for the filter base materials to be used in a air cleaning filter as mentioned above. The problem is related to that the filter base material of PLA becomes collapsed and/or compressed during the process of fabricating the material, in particular in the process of fabricating a carded thermobonded nonwoven filter base material. For example, this may cause undesired high-pressure drops of an air stream passing through the filter base material of a filter, typically being a filter of class G4 to F6 according to EN 779, in particular of class G4, F5 or F6.

Thus, a problem associated with prior-art filter base materials of PLA is that in the process of fabricating the filter base material it may be difficult to control the properties of the final product, so as to adjust the filter base material to a desired filter type. For example, a filter base material of PLA would many times results in unacceptable pressure drops. Therefore, prior-art filter base materials of PLA would many times require a large filter area to efficiently filtrate particulates while the pressure drop is kept low. Therefore, a PLA consisting filter base material might result in a filter or filter base material that has to be replaced very often, or even result in a non-functional and/or an undesired filter.

Therefore, there is a need for an improved fluid cleaning filter comprising filter base material including a renewable and non-polluting material.

### SUMMARY OF THE INVENTION

In view of the aforementioned respects of known fluid cleaning filters and filter base materials, an object of the present invention is to provide an improved and/or alternative filter base material and fluid base filters comprising the filter base material.

The object is wholly or partially achieved by a use of a material as a filter base material, a method for fabricating a filter base material, a filter base material provided by the method and a filter comprising the filter base material. Embodiments are set forth in the appended dependent claims, in the following description and in the drawings.

According to a first aspect of the invention there is provided a use of a material as a filter base material for a fluid cleaning filter. The filter base material comprises a polylactic acid and a non-polylactic acid polyester. The polylactic acid and non-polylactic acid polyester are in the form of fibers. The filter base material further comprises a binding component for binding the fibers together. The binding component have a lower melting point than the above mentioned polyesters.

Filter base material here means the major part of a filter that provides the filtration of a fluid stream such as an air stream passing through the filter, which part many times also is referred to as a filter medium.

Non-polylactic acid polyester here means polyester, which may be any polyester that is not a polylactic acid, including copolymers thereof. One example is polyethylene terephthalate and copolymers thereof. A polylactic acid may be pure polylactic acids or in certain embodiments also copolymers thereof.

Such a filter base material provides the possibility of controlling the fabrication of a filter base material so as to provide the desired properties of a fluid cleaning filter such as an air cleaning filter. For example, at given initial and final pressure drops, the filter may achieve a desired dust spot efficiency, particle efficiency and dust weight arrestance aimed for a certain filter application such as for example protection of heat and cooling exchange equipment.

Moreover, a mixture of this kind provides the possibility for a skilled person to produce a disposable air cleaning filter with a minimum of nonrenewable materials included in the mixture, while the filter base material comprising this mixture allows the desired properties of the filter base material, such as a low pressure drop at a desired efficiency, high or low, depending on the particles targeted for filtration. For example, by the use of the described material, it is possible to control the fabrication of the filter base material, so as to achieve an air cleaning filter of, for example, G4 to F6 class according to standard EN 779, in particular of class G4, F5 or F6. Moreover, the material makes it possible that, for example, in today's existing HVAC equipments or air conditioning equipments, to reduce the use of non-renewable filter types with petrochemical-derived fibers. Furthermore, the invention facilitates the replacement of these petrochemical-derived fiber filters because the filters comprising the above filter base material may replace the petrochemical-derived fiber filters, while there is no need for adjusting the air exhaust or inlet fans, no need for change of filter types or arrangements such as frames, and no change in or even fewer number of filter pockets or fewer filter pleats, depending on the desired filter type.

The material of fibers provides the possibility of avoiding a collapsed or compressed filter based material in filter media process, so as to provide a desired “high loft” material and/or desired properties for certain filters as mentioned above. Furthermore, the binding component provides the possibility of an efficient thermobonding of the fiber mixtures, so as to provide the desired “high loft” material, for example.

According to one embodiment, the filter base material may comprise a nonwoven material of the fibers.

Such a nonwoven material provides the possibility of avoiding a collapsed or compressed filter based material in a filter media process, so as to provide a desired “high loft” material and/or desired properties for certain filters as mentioned above.

According to one embodiment, the material may be a carded nonwoven material of fibers.

The carded fiber mixture provides the possibility of avoiding a collapsed or compressed filter based material in a carded nonwoven filter media process, so as to provide a desired “high loft” material and/or desired properties for certain filters as mentioned above. The carded material may preferably be thermobonded by heating the carded mixture, so as to form the desired material. The inventive material may solve any problem with collapsed or compressed filter base material in the fabrication of a carded thermobonded nonwoven filter media process, in particular for filter base materials for use in filters of class G4, F5 or F6, for which classes there may be a problem with collapsed or compressed PLA filter base material.

According to one embodiment, the non-polylactic acid polyester may be aromatic polyester.

According to one embodiment, the aromatic polyester may be polyethylene terephthalate.

A mixture of PLA and aromatic polyester of this kind provides the possibility of a “high loft” fiber base material, which provides the desired properties of certain filters as mentioned above, and efficiently filtrates particulates in an air stream, while the pressure drop is kept low for example. Moreover, the aromatic polyester provides the possibility to make the filter base material mechanically stronger compared to materials of PLA.

According to one embodiment, the binding component may be polyolefin such as polyethylene or polypropylene, non-polylactic acid polyester such as aromatic polyester like the one mentioned above, a polylactic acid and/or a copolymer thereof.

According to one embodiment, the PLA may constitute around 10% by weight or more, 25% by weight or more, or 50% by weight or more of the filter base material or a portion of the filter base material.

A portion of the filter base material here means a portion of different fiber composition than another portion of the filter base material. For example, the portions may be the layers as described below for the multilayered fiber web comprising at least two layers of different fiber compositions. By the amount of PLA and non-PLA polyester, it is possible to provide a filter base material that fulfills the filtration performance requirements while still providing an environmental benefit over pure petrochemical-derived filter base materials. In particular, there is provided a possibility of controlling the fabrication of the inventive filter base material, so as to provide a desired type of filter base material.

According to a second aspect of the invention, there is provided a method for fabricating a filter base material. The method comprises carding a material comprising polylactic acid fibers and non-polylactic acid polyester fibers, wherein a single-layered planar fiber web is provided. The method further comprises stabilizing the material of the planar fiber web by binding or bonding fibers in the material together, wherein a nonwoven planar fiber web is provided.

The method provides a way of fabricating the material for use as a filter base material.

According to one embodiment, the method further comprises placing portions of the single-layered fiber web or several carded single-layered fiber webs, before the step of stabilizing the material, so as to form a multilayered planar fiber web.

In this way, it is provided a way of controlling certain properties of the filter base material, such as weight per area unit as well as a way of achieve a high quality of the material such as a fine structure as compared to a filter base material of a “thick” single-layered web.

The multilayered web may comprise at least two layers of different fiber compositions.

By such a multilayered web it is possible to provide a progressive filter base material as discussed below.

According to one embodiment, the carded single-layered fiber web comprises at least two portions presenting substantially juxtaposed projections on a principle plane of the web, wherein the method comprises folding the single-layered web. In this way, the multilayered web comprising the at least two layers of different fiber compositions may be formed.

Presenting substantially juxtaposed projections here means that the two portions are joined together so as to present the juxtaposed projections. As should be appreciated, the web, and also the portions are substantially planar. This means that a partially planar overlapping of the portions may be allowed, depending on the means for joining the portions. The portions may also be placed edge to edge. Accordingly, the web can be produced by joining the separate portions, by attaching one edge of a portion to an edge of another portion, in an edge-to-edge manner or in an overlapping manner. Furthermore, the web may also be produced as a single unit, wherein the portions are comprised in the unit, e.g. as is known to the person skilled in the art, by feeding two different mixtures of fibers to a carding machine side by side and carding the two mixtures at the same time, wherein a the web is formed with the two portion running in the carding as well as feeding direction.

By this method a filter base material may be produced, wherein it is possible to construct a filter base material with progressively finer fibers of the inventive material through the filter base material as viewed from the air entrance side to the air outlet side of the filter in which the filter base material is included. The progressive filter base material provides the possibility of a “high loft” fiber base material, which efficiently filtrates particulates in an air stream, for example, while the pressure drop is kept low. It is also provided a possibility to use a minimal filter surface area, being planar or pleated or any other form that is known to the person skilled in the art.

According to further embodiments of the method the mixture may comprise any one of the specified components and amounts as described above.

According to one embodiment, heating the material, wherein thermobonding occurs, provides the stabilizing step.

Thermobonding provides a simple and good way of stabilizing the multilayered web that is easy to handle.

According to a third aspect of the invention there is provided a filter base material for use in a fluid cleaning filter, wherein the filter base material is produced according to the method above.

Such a material provides the advantages as discussed above.

According to a fourth aspect of the invention there is provided a fluid cleaning filter comprising the filter base material as mentioned above.

Such a filter benefits from the above filter base material.

The invention will now be explained in more detail below with reference to embodiments and examples.

### DESCRIPTION OF THE DRAWINGS

FIG. 1 shows one embodiment of a filter comprising a filter base material.

FIG. 2 shows a schematic top view of one embodiment of an arrangement of fabricating a filter base material.

FIG. 3 shows a schematic top view of one embodiment of an arrangement of fabricating a progressive filter base material.

### DETAILED DESCRIPTION OF THE INVENTION AND EMBODIMENTS

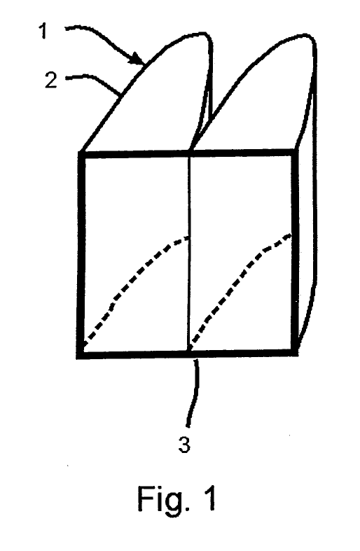

FIG. 1 shows a schematic view of a filter comprising a filter base material according the present invention. The filter comprises a filter bag system 1 including the filter base material 2, wherein the system is mounted in a frame 3. The filter base material 2 comprises a polylactic acid and non-polylactic acid polyester such as aromatic polyester. The filter base material 2 may further comprise any material as discussed below, such as a binding component. As is evident for the skilled man in the art, the filter base material 2 may also be used in any type of filter other than the one shown in FIG. 1, which filter may benefit of the use of the filter base material comprising a polylactic acid and an non-polylactic acid polyester. Examples of such filter types are pleated filters and planar filters.

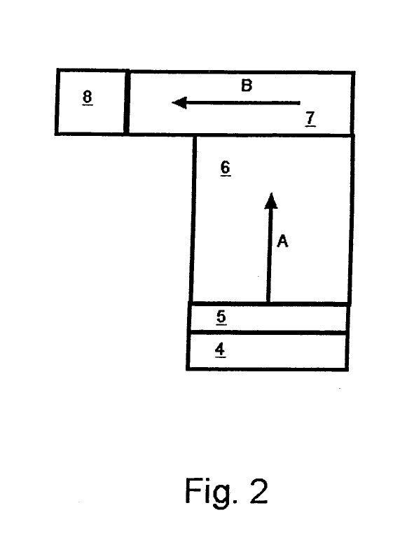

The filter base material 2 may be produced according to a method as illustrated by the arrangement in FIG. 2. The method comprises mixing ready-made fibers comprising PLA and non-PLA polyester such as polyethylene terephthalate (PET), and a binding component such as PLA, PET, polyolefin (e.g. polyethylene and polypropylene) or copolymers thereof. The resulting mixed fibers is placed in a hopper feeder 4 from which the fibers are fed to a carding machine 6 by feeding the mixed fibers via a vibrating feeder 5 that is generally known as a “vibra feed” to the carding machine 6 in a direction A. The carding machine 6 cards the fibers so as to form a planar fiber web. The carded planar fiber web is fed in the direction A into a lapper 7, wherein the fiber web is laid in several layers by using any lapping method that is known to the skilled man in the art, such a cross-lapping method using a cross lapper 7, and thereby forming a multi-layered web. As a cross lapper 7 to be used for producing the cross-lapped multilayered web, any suitable cross lapper 7 that is known to the person skilled in the art for laminating nonwoven fabrics, such as an horizontal cross lapper 7, may be used. The multi-layered web is fed (in a feeding direction B that is perpendicular to the feeding direction A) into an oven 8, such as a normal oven or in a through air heating oven, such as a drum or planar type of oven (dryer) that is known to the skilled person, whereby thermobonding of fibers occur, for example, i.e. the binding component is melting and binding the fibers together, and wherein the final filter base material is formed. The carded mixture may be heated for around 1 to 5 minutes at around 80 to 180° C., in particular at around 110-150° C., e.g. 1 to 2 minutes at around 120 to 130° C. for a filter base material to be used in a F5 class of filter, wherein thermobonding occurs and the final filter base material is formed. As will be appreciated by the person skilled in the art, the heating temperature depends on the filter base material to be prepared and factors such as the heating time, desired thickness of the filter base material and the types of fibers included in the material. Cutting and uncoiling, or any other finishing as is known to the person skilled in the art may then finalize the resulting material.

As an example of fabricating the filter base material as illustrated in FIG. 1, the mixed fibers may be fed to the carding machine 6, wherein the carding occurs and the accumulated carded planar fiber web may be introduced in a horizontal cross lapper 7 (fed in the direction A) without being cut off, continuously cross lapped to form multilayer, for example, generally lapping at least eight layers or sheets to form multilayer, placed on a belt and continuously fed in a direction B to a stabilizing oven 8 for thermobonding the multilayered web to for the filter base material. By this way a non-progressive filter base material may be formed.

The “staple” fibers may be in the mass range of 1.7 to 17.0 dtex (the mass in grams per 10,000 meters) having a length of 38 to 95 mm. Examples of fibers are the PLA fibers having 1.7, 3.3, 6.7 and 17 dtex, and the PET fibers of 1.7 3.3, 6.7, 12 and 17 dtex. The binding component may comprise a polyester or a polyolefin, such as polyethylene and polypropylene, and copolymers thereof. The binding component has a melting point that is lower than the melting points for the PET and PLA fibers. The binding component may in turn form a portion of a fiber known as a bicomponent fiber. A bicomponent fiber consists of a sheath of the binding component and a core of polyester, for example, the core having higher melting point than the sheath. Examples of core materials are polylactic acids and/or non-polylactic acids such as PET. This bicomponent fibers may also be fibers of the mass range of 1.7 to 17 dtex, e.g. have 2.2, 2.4, 7 and 17 dtex. Typically, the binding component constitutes around one third by weight of the bicomponent fiber. Preferably, the binding component has a melting point around 90 to 130° C., in particular around 110° C. as is normal for a PET based copolymer. The melting point of the “staple” fibers such as the PET fibers may usually be more than around 200° C., e.g. around 237 to 250° C. Anyhow, the skilled person in the art will appreciate that the parameters are depending on the type the filter base material that is produced. The choice of the parameters, types of fibers and process apparatuses among other things are also evident for the person skilled in the art.

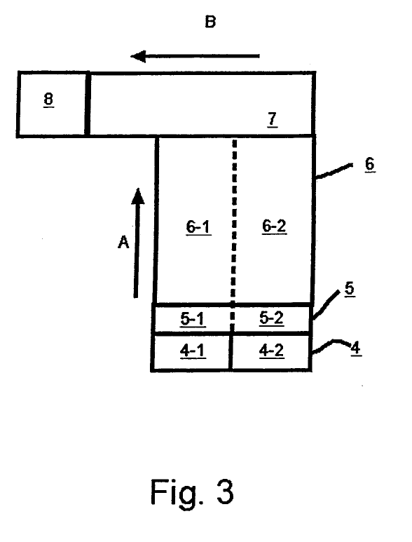

According to one embodiment, the filter base material may be progressively arranged. A progressive filter may be provided by fabricating a coarse fiber web and a fine fiber web, wherein the fine fiber web is melt blown directly on the coarse fiber web. In other embodiments, the fine fibers can be adhesively bonded to or laminated onto the coarse fiber web. The progressive filter base material may be fabricated by the method mentioned below in connection with FIG. 3.

One embodiment of the method for fabricating a filter base material is illustrated by the arrangement in FIG. 3. The method is based on the method as discussed in connection with FIG. 2 above. The method differs from the latter one in that the hopper feeder 4 is divided into two chambers 4-1; 4-2, wherein each may comprise a different mixture of fibers during the process of fabricating the material. From the chambers 4-1; 4-2, the mixtures are fed to the carding machine 6 via the so called “vibra feed” 5. In the carding machine 6, a single-layered fiber web is formed that is substantially planar. The web is divided into two portions 6-1; 6-2 presenting substantially juxtaposed projections on a principle plane of the web. Each composition of the portions 6-1; 6-2 corresponds to one of the mixtures that are fed from the hopper feeder 4. The single-layered fiber web is fed to a cross lapper 7, wherein the fiber web is laid in several layers forming a multi-layered fiber web as discussed above. The portion 6-2 of the single-layered fiber web constitutes the layer or layers formed on the lower part of the multilayer web during the cross-lapping of the web, and consequently the portion 6-1 constitutes the layer or layers formed on the upper part during the cross lapping. By the illustrated method, it is possible to form a progressive filter base material. The carded single-layered web may comprise more than the two portions 6-1; 6-2 illustrated in FIG. 3, for example, three portions. The skilled man will appreciate that number of portions may be modulated by selecting corresponding number of separate hopper feeder chambers 4-1; 4-2. Moreover, as will also be appreciated, the width of the chambers 4-1; 4-2 cross the feeding direction may be adjusted so as to form a carded single-layered web that have portions of equal or non-equal sizes and/or weights per area unit filter base material, whereby the corresponding portions of the cross-lapped web may be controlled as regard to the material proportion between the portions in the multilayered fiber web.

The number of the layers of the multilayered web is appropriately selected taking into consideration the diameter of fiber to be used, the successive processing, the aimed unit weight of the product to be obtained, the purpose of use of the final filter base material product and so forth. In order to assure the uniformity of the cross-lapped web unit weight, desirably at least 8, more desirably 12 to 35 sheets should be arranged and as a specific example may be mentioned the one given in the section referring to examples below.

The unit weight of the cross-lapped web varies depending upon the thread diameter and the unit weight of the aimed final product, but is desirably 100 to 500 g/m².

According to one embodiment, the filter base material is to be used in a filter of class G4, F5 or F6, and in particular in a class F5 filter. The material provides the possibility of avoiding a collapsed and/or compressed filter base material as discussed above.

According to one embodiment, the filter base material consists of or consists essentially of PET fibers, PLA fibers and bicomponent fibers.

According to embodiments, the PLA may constitute around 95% by weight or less, 90% by weight or less, 80% by weight or less, 70% by weight or less or 60% by weight or less of the filter base material or a portion of the filter base material, but not less than around 10% by weight, around 25% by weight, or around 50% by weight of the filter base material or a portion of the filter base material.

According to one embodiment, the filter base material is for use in an air cleaning filter.

The filter base material may be used for mechanical or electrostatic filtration.

### EXAMPLES

The invention will now be illustrated further through the non-limiting recital of experiments conducted in accordance therewith. In these experiments the aspects of different compositions of filter base materials on providing a “high loft” material were tested.

### Experimental Procedures

The filter types that were aimed to be produced were the ones belonging to the F5 filter class measured according to the Eurovent standard EN779:2002, wherein an F5 class filter corresponding to minimum average dust collection efficiency of 40% of particles having a size around 0.4 μm. The thickness of the produced filter base material of that class should preferably be from 6 to 35 mm

Three samples were prepared using the method described above in connection with FIG. 3. For each sample, two mixtures were prepared, of which one mixture was placed in one hopper feeder chamber 4-1 and the other mixture in the other chamber 4-2. The PET fibers that were used for preparing the mixtures are shown in table 1. The PET bicomponent fibers contained a core of PET having a coated sheath of a copolymer of PET, the latter having a melting point of around 110° C., which is much lower than the melting point for the PET and the PLA as mentioned above. The PLA fibers that were used for preparing the mixtures are shown in table 2. The PLA bicomponent fibers contained a core of PLA having a coated sheath of a copolymer of PLA, the latter having a melting point of around 110 to 130° C., which is much lower than the melting point for the PLA as well as the PET. The sheath of the bicomponent fibers constituted around one third by weight of the bicomponent fibers. Table 3 illustrates the fiber mixtures prepared from the fibers, which mixtures in turn were used for preparing the different samples. The mixtures used for each sample are set forth in table 4, wherein sample 1 was prepared as a comparative example containing 100% by weight of PLA.

The hopper feeder chambers 4-1; 4-2 were equally wide cross the feeding direction, i.e. each chamber 4-1; 4-2 was 1.20 m wide cross the feeding direction. The mixtures were fed so as to provide a carded single-layer fiber web of 9 g/m² comprising two planar portions placed side-by-side and of essentially equal weights and sizes. The carded single-layered web was horizontally cross lapped to form a multilayered fiber web of 28 layers, of which the 14 bottom layers comprised one mixture for providing a fine fiber structure of the lower part of the planar web, and the 14 top layers for providing a coarse fiber structure of the upper part of the planar web. The material feeding velocities into the cross lapper 7 and from the cross lapper 7 were adjusted so as to provide the 28 layers, as is known to the skilled person in the art. For example, the speed from the cross lapper 7 to and through the oven 8 mentioned below was for each sample around 3.5 m/min (the webs being 2 m wide cross the feeding direction). The multilayered webs were heated in an oven 8 of the drum type (Fleichner) by a so called “through air heating process” for around 1.5 to 2 minutes at around 120° C. for samples 1 and 2, and at 130° C. for sample 3. The produced filter based materials each had a weight per square meter of 250 g.

TABLE 1
PET based fibers used for preparing samples

| Solid Fiber (SF) | Bicomponent Fiber (BF) |
|---|---|
| SF-A: 1.5 Den, 57 mm | BF-A: 2 Den, 51 mm |
| (Tesil 84; Silon) | (SN3250CM; Far Eastern) |
| SF-B: 3 Den, 57 mm | BF-B: 4 Den, 51 mm |
| (Tesil 84; Silon) | (SN3450CM; Far Eastern) |

TABLE 2
Polylactic acid based fibers used for preparing samples

| Solid Fiber (SF) | Bicomponent Fiber (BF) |
|---|---|
| SF-C: 1.5 Den, 51 mm | BF-C: 2 Den, 51 mm |
| (SLN2552D; Far Eastern) | (SLN2250CM; Far Eastern) |
| SF-D: 3 Den, 51 mm | BF-D: 4 Den, 51 mm |
| (SLN2350D Far Eastern) | (SLN2450CM; Far Eastern) |

TABLE 3
Fiber mixture contents

| Fiber | Fiber Type and Amount of Fiber (% (wt/wt)) | | | | | | | |
|---|---|---|---|---|---|---|---|---|
| Mixture | SF-A | SF-B | SF-C | SF-D | BF-A | BF-B | BF-C | BF-D |
| FM-A | — | — | 40 | — | — | — | 60 | — |
| FM-B | — | — | — | 50 | — | — | — | 50 |
| FM-C | — | — | — | 50 | — | 50 | — | — |
| FM-D | — | — | 50 | — | 50 | — | — | — |
| FM-E | 40 | — | — | — | 60 | — | — | — |
| FM-F | — | 25 | — | 25 | — | 50 | — | — |

TABLE 4
Contents in the sample filter base material

| Sample | Amount of PLA | Type of Fiber mixture and amounts thereof (% (wt/wt)) | | | | | |
|---|---|---|---|---|---|---|---|
| number | (% (wt/wt)) | FM-A | FM-B | FM-C | FM-D | FM-E | FM-F |
| 1 | 100 | 50 | 50 | — | — | | — |
| 2 | 50 | — | — | 50 | 50 | | — |
| 3 | 12.5 | — | — | — | — | 50 | 50 |

### Results

As mentioned above, the filter types that were aimed to be produced were the ones belonging to the F5 filter class and the thickness of the produced filter base material of that filter class should preferably be from 6 to 35 mm. In particular, the thickness should preferably be well above 6 mm.

The thicknesses of the sample filter base materials are set forth in table 5.

TABLE 5

| | Amount | Thickness of the |
|---|---|---|
| Sample | of PLA | nonwoven material (mm) |
| number | (% (wt/wt)) | (“high loft”) |
| 1 | 100 | 5-7 |
| 2 | 50 | 14-16 |
| 3 | 12.5 | 14-16 |

From the data shown in table 5, it is evident that a filter base material and/or mixture of PLA and PET provides a nonwoven fiber base material that has a remarkable increased thickness as compared to the material of sample number 1 comprising 100% by weight of PLA. Thus, sample number 2 and 3 are both indicated as well suited for use in F5 class filters.

From the data, it is further evident that the filter base material comprising around 50% by weight of PLA (sample 2) provides the wished material as based on the thickness of 14 to 16 mm. Furthermore, it is also evident that the filter base material comprising 12.5% by weight of PLA (sample no. 3) has a portion (coarse fiber portion) with around 25% by weight of PLA that provides the desired material. Thus, it is possible to provide a filter base material that fulfills the filtration performance requirements while still providing an environmental benefit over pure petrochemical-derived filter base materials. In particular, the results indicate the possibility of controlling the fabrication of the inventive filter base material, so as to provide a desired type of filter base material. The skilled man will appreciate that it may be possible to provide a “high loft” material comprising 100% by weight of PLA by adjusting fabrication parameters, but that such a material will be soft and shapeless, and not have a rigidity and a stability that are required for the application as a filter base material. For example, the degree of stabilized fibers by thermobonding may be very low causing a undesired material. It is also appreciated that it may be possible to control the fabrication of a filter base material of class F5, so as to provide a filter base material of 250 g/m² that has been stabilized by, for example, thermobonding, so as to achieve filter base materials having a thickness in the following ranges: a) 4 to 7 mm for a material of 100% PLA (wt/wt), b) 7 to 20 mm for a material of 50% PLA (wt/wt), and c) 7 to 20 mm for a material of 10% PLA (wt/wt). Thus, it may be possible to control the fabrication of the inventive filter base material, so as to provide a desired type of filter base material that is rigid and stable.

Therefore, a filter base material made of a mixture of PLA and PET provides an attractive alternative to the pure petrochemical-derived filter as well as to the PLA consisting filter base material. In particular, a filter base material comprising PLA and PET as described above, wherein the PLA constitutes 12.5% by weight or more, 25% by weight or more, or in particular 50% by weight or more, may provide the attractive alternative.

1. A material for a filter base for a fluid cleaning filter, comprising a first polylactic acid and a first non-polylactic acid polyester wherein the first polylactic acid and the first non-polylactic acid polyester are in the forms of fibers, and wherein the material further comprises a binding component for binding the fibers together, the binding component having a lower melting point than the first non-polylactic acid polyester and the first polylactic acid.

2. The material according to claim 1, wherein the material comprises a nonwoven material.

3. The material according to claim 2, wherein the material is a carded nonwoven material.

4. The material according to claim 1, wherein the first non-polylactic acid polyester is an aromatic polyester.

5. The material according to claim 4, wherein the aromatic polyester is polyethylene terephthalate.

6. The material according to claim 1, wherein the binding component comprises a second polylactic acid, a second non-polylactic acid polyester, a polyolefin and/or a copolymer thereof.

7. The material according to claim 6, wherein the second non-polylactic polyester is an aromatic polyester.

8. The material according to claim 7, wherein the second non-polylactic polyester being an aromatic polyester is polyethylene terephthalate.

9. The material according to claim 1, wherein polylactic acid content constitutes around 10% by weight or more, around 25% by weight or more, or around 50% by weight or more of the filter base material or a portion of the filter base material.

10. A method for fabricating a filter base material, the method comprising:
carding a material comprising polylactic acid fibers and non-polylactic acid polyester fibers, wherein a single-layered planar fiber web is provided;
stabilizing the material of the planar fiber web by binding or bonding fibers in the material together, wherein a nonwoven planar fiber web is provided.

11. The method according to claim 10, further comprising:
placing portions of the single-layered fiber web or several single-layered fiber webs, before the step of stabilizing the material, so as to form a multilayered planar fiber web.

12. The method according to claim 11, wherein the multilayered web comprises at least two layers of different fiber compositions.

13. The method according to claim 12, wherein the carded single-layered fiber web comprises at least two portions presenting substantially juxtaposed projections on a principle plane of the web, wherein the method comprises folding the single-layered web, so as to form the multilayered web comprising the at least two layers of different fiber compositions.

14. The method according to claim 10, wherein the non-polylactic acid polyester is an aromatic polyester.

15. The method according to claim 14, wherein the aromatic polyester is polyethylene terephthalate.

16. The method according to claim 10, wherein the material comprising polylactic acid fibers and non-polylactic acid polyester fibers further comprises a binding component for binding the fibers together, which binding component has a lower melting point than the non-polylactic acid polyester fibers and polylactic acid fibers.

17. The method according to claim 16, wherein the binding component comprises a polylactic acid, a non-polylactic acid polyester, a polyolefin and/or a copolymer thereof.

18. The method according to claim 10, wherein heating the material, wherein thermobonding occurs, provides the stabilizing step.

19. A filter base material obtainable according to the method as claimed in claim 10.

20. A fluid cleaning filter comprising the filter base material as claimed in claim 19.
